(19) United States
(12) Patent Application Publication
(10) Pub. No.: US 2026/0323496 A1
(43) Pub. Date: Oct. 15, 2026

(54) SMF COMMUNICATION OF 5G SLICE IDENTIFICATION

(71) Applicant: T-MOBILE INNOVATIONS LLC, Overland Park, KS (US)

(72) Inventors: A. Karl CORONA, Maple Valley, WA (US); Joel Lee ARENDS, Renton, WA (US)

(21) Appl. No.: 19/175,583

(22) Filed: Apr. 10, 2025

(51) Int. Cl. H04W 48/18; H04L 65/1016; H04L 65/1045; H04W 76/10

(52) U.S. Cl. CPC H04W 48/18; H04L 65/1016; H04L 65/1045; H04W 76/10

(57) ABSTRACT

Systems and methods are provided for managing communication sessions for user equipment (UE) over a 5G telecommunications network. Specifically, slice-specific information is communicated from the 5G core network to the IP Multimedia Subsystem (IMS) network using the N4 interface between the Session Management Function (SMF) and the User Plane Function (UPF). The SMF transmits slice identifiers, such as the S-NSSAI, to the UPF over the N4 interface, enabling the UPF to embed this information into outgoing packets via techniques like custom header shims, DSCP markings, or SIP headers. These enhanced packets are transmitted over the N6 interface to the IMS network, where the Policy Control Function (PCF) dynamically enforces slice-specific policies tailored to user and application requirements.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for a mechanism for the Internet Protocol Multimedia Subsystem (IMS) Proxy Call Session Control Function (P-CSCF) to determine slice identification information for each user during the IMS registration process.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2A depicts a diagram of a flow for communicating network slice information to the IMS using DSCP in which implementations of the present disclosure may be employed, in accordance with aspects herein;

FIG. 2B depicts a diagram of a flow for communicating network slice information to the IMS using a custom header shim in which implementations of the present disclosure may be employed, in accordance with aspects herein;

FIG. 2C depicts a diagram of a flow for communicating network slice information to the IMS using a custom SIP header in which implementations of the present disclosure may be employed, in accordance with aspects herein;

FIG. 2D depicts a diagram of a flow for communicating network slice information to the IMS using an xml body in which implementations of the present disclosure may be employed, in accordance with aspects herein;

FIG. 3 depicts a flow diagram of a method for communicating network slice information to the IMS early in the registration process using the N4 interface, in accordance with aspects herein; and

FIG. 4 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. Further, various technical terms are used throughout this description. An illustrative resource that fleshes out various aspects of these terms can be found in Newton's Telecom Dictionary, 22d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

As used herein, a UE (also referenced herein as a user device) or WCD (wireless communication device) can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

By way of background, the integration of Fifth Generation (5G) core networks and Internet Protocol Multimedia Subsystem (IMS) networks is critical for enabling advanced multimedia services such as voice and video calls over internet protocol (IP). 5G networks introduced network slicing, where distinct virtualized network segments, or “slices,” are created to meet specific service requirements. For example, one slice may be optimized for ultra-reliable low-latency applications, while another may prioritize high bandwidth for streaming. However, IMS networks lack an efficient mechanism to identify and utilize the network slice information early in the registration process, which limits their ability to apply slice-specific policies, such as security protocols, quality-of-service (QoS) optimizations, or encryption.

Conventionally, IMS networks operate without explicit integration of 5G network slice information. While the 5G core network can manage slice-specific QoS and mobility through functions like the Session Management Function (SMF) and User Plane Function (UPF), this information is typically confined to the 5G core. The Proxy Call Session Control Function (P-CSCF), which serves as the first point of contact for a user device accessing the IMS network, handles tasks such as Session Initiation Protocol (SIP) signaling, QoS enforcement, and security configurations. However, the P-CSCF relies on static configurations or generic policies that do not account for the unique requirements of specific slices. Without access to slice-specific information, the IMS network is unable to dynamically tailor policies or optimize services based on the distinct characteristics and demands of each slice, limiting its ability to provide seamless, high-quality service for diverse applications.

The present disclosure introduces a method to transmit network slice information from the 5G core directly to the IMS network during the initial registration process. By embedding the slice information into signaling messages or data packets, the disclosure enables the P-CSCF to dynamically apply slice-specific policies, such as per-subscriber encryption, QoS adjustments, and enhanced security protocols. This approach not only ensures seamless integration between the 5G core and IMS but also enhances service delivery by tailoring IMS policies to the requirements of each slice. Additionally, the present disclosure supports various mapping techniques, such as embedding slice information in differentiated service parameters or custom SIP headers.

Accordingly, a first aspect of the present disclosure is directed to a method for enabling communication between a 5G core network and an internet protocol multimedia subsystem (IMS) network. The method comprises obtaining, by a mobile network operator (MNO) system, at a session management function (SMF) of the 5G core network, network slice information associated with a user equipment (UE) based on a network slice identifier. The method also comprises transmitting, by the MNO system, the network slice information from the SMF to the user plane function (UPF) via an N4 interface. The method further comprises embedding, by the MNO system, the network slice information into one or more of signaling messages or data packets at the UPF, wherein the signaling messages or data packets are destined for the IMS network. Additionally, the method comprises transmitting, by the MNO system, the network slice information to a proxy call session control function (P-CSCF) of the IMS network, and enabling, by the MNO system, enforcement of one or more network policies or configurations at the IMS network based on the network slice information.

A second aspect of the present disclosure is directed to a system for enabling communication between a 5G core network and an IMS network. The system comprises one or more processors; and one or more computer-readable media storing computer-usable instructions that, when executed by the one or more processors, cause the one or more processors to obtain network slice information associated with a user equipment (UE) based on a network slice identifier at a session management function (SMF) of the 5G core network. The system also comprises transmitting the network slice information from the SMF to the user plane function (UPF) via an N4 interface, and embedding the network slice information into one or more of signaling messages or data packets at the UPF, wherein the signaling messages or data packets are destined for an IMS network. Additionally, the system comprises transmitting the network slice information to a proxy call session control function (P-CSCF) of the IMS network, and enabling enforcement of one or more network policies or configurations at the IMS network based on the network slice information.

Another aspect of the present disclosure is directed to a computer-readable medium storing instructions that, when executed by a processor, cause the processor to perform a method for enabling communication between a 5G core network and an internet protocol multimedia subsystem (IMS) network. The method comprises obtaining, by a mobile network operator (MNO) system, at a session management function (SMF) of the 5G core network, network slice information associated with a user equipment (UE) based on a network slice identifier. The method also comprises transmitting, by the MNO system, the network slice information from the SMF to the user plane function (UPF) via an N4 interface. The method further comprises embedding, by the MNO system, the network slice information into one or more of signaling messages or data packets at the UPF, wherein the signaling messages or data packets are destined for the IMS network. Additionally, the method comprises transmitting, by the MNO system, the network slice information to a proxy call session control function (P-CSCF) of the IMS network, and enabling, by the MNO system, enforcement of one or more network policies or configurations at the IMS network based on the network slice information.

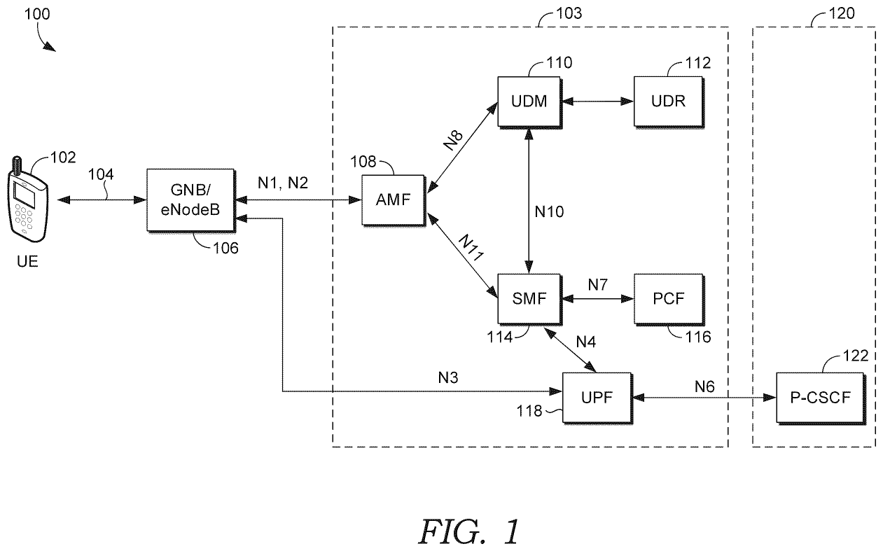

Turning to FIG. 1, a network environment suitable for use in implementing embodiments of the present disclosure is provided. The network environment, designated generally as network environment 100, is a simplified example of a suitable network environment and is not intended to suggest any limitation as to the scope of use or functionality of the disclosure. Neither should the network environment 100 be interpreted as having any dependency or requirement relating to any one or combination of components illustrated. Generally, the network environment 100 comprises one or more UEs (e.g., UE 102), a radio access network (RAN) node (e.g., eNodeB 106), a core network (e.g., 5G core network 103), and an IMS network (e.g., IMS network 120), which may be either part of a single system or separate entities interacting through defined interfaces.

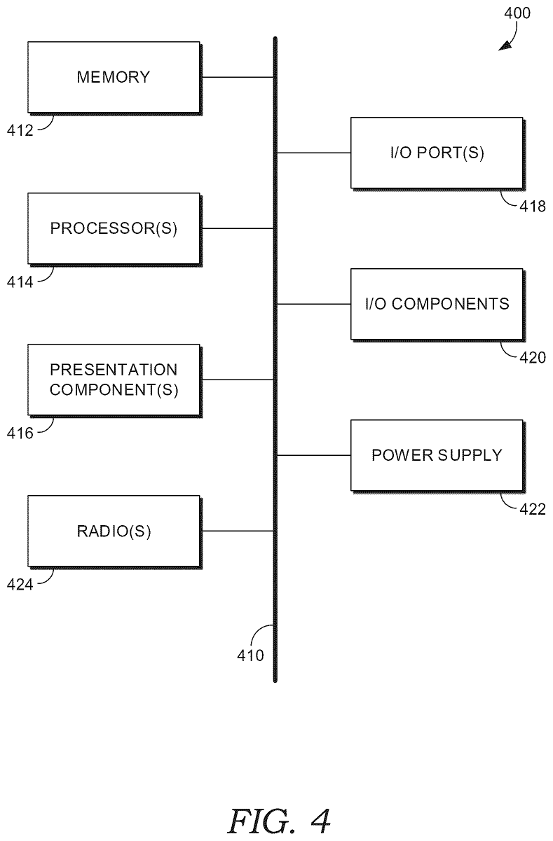

The network environment comprises at least a UE 102, having any one or more aspects of the computing device 400 of FIG. 4. In the network environment 100, UE 102 may communicate with other devices, such as mobile devices, servers, etc. In aspects, the UE 102 may correlate to a user with a specific subscription plan. In embodiments, the network 100 is a telecommunications network, or a portion thereof. A telecommunications network may include an array of devices or components, some of which are not shown to avoid obscuring more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, a GNB/eNodeB 106 is associated with a network associated with a telecommunications provider that provides services to user devices, such as UE 102, through connection 104. For example, the network may provide voice services to user devices or corresponding users that are registered or subscribed to utilize the services provided by a telecommunications provider. The IMS network 120 is also depicted in FIG. 1, either as an integrated part of the telecommunications infrastructure or as a separate but interconnected subsystem that interacts with the 5G core network 103.

The core network 103 portion of the network environment 100 comprises a plurality of network functions, including an access and mobility management function (AMF) 108, a unified data management (UDM) 110, a unified data repository (UDR) 112, a session management function (SMF) 114, a user plane function (UPF) 118, and a policy control function (PCF) 116, as well as several interfaces that connect the network functions. The N1 interface is a transparent interface from the UE 102 to the AMF 108 and is used to transfer UE information to the AMF 108. The N2 interface connects the gNodeB 106 to the AMF 108. The AMF 108 handles connection and management mobility tasks. Essentially, the AMF 108 plays the role of the access point to the 5G Core Network. The N8 interface connects the AMF 108 to the UDM 110. It is used during the registration process when the AMF 108 needs user data from the UDM 110 for UE authentication purposes. The N11 interface connects the AMF 108 to the SMF 114. The SMF 114 interacts with the AMF 108 to establish, manage, and terminate sessions. Essentially, when the UE 102 requests a new session, the UE 102 and the gNodeB 106 use the N1 and N2 interfaces to carry messages to the AMF 108. The AMF 108 manages the connection and mobility management and then passes the request on to the SMF 114 via the N11 interface.

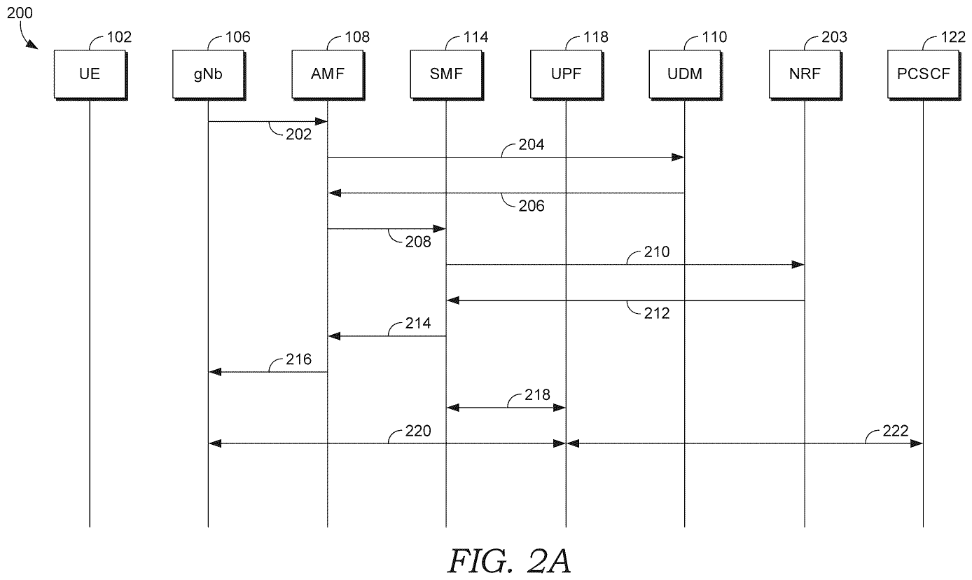

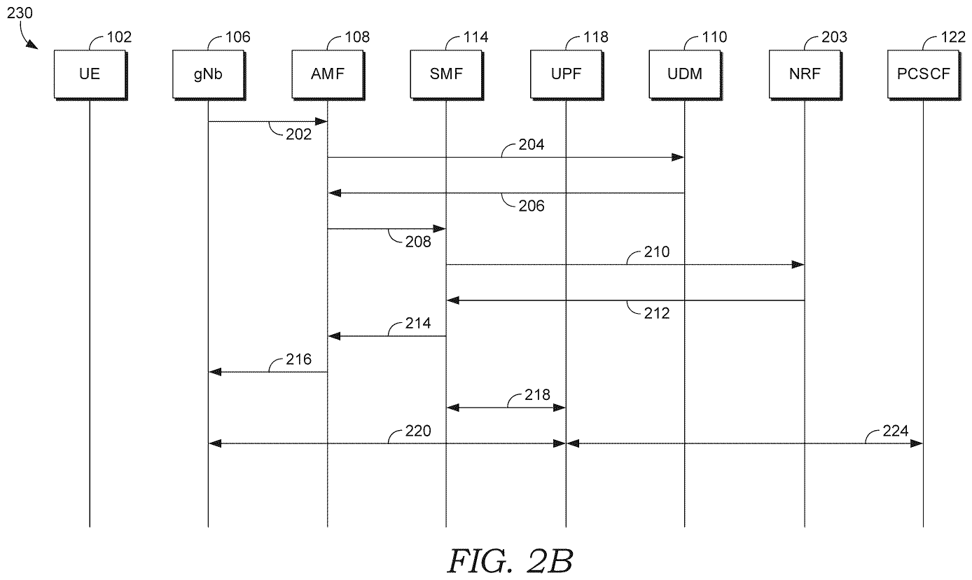

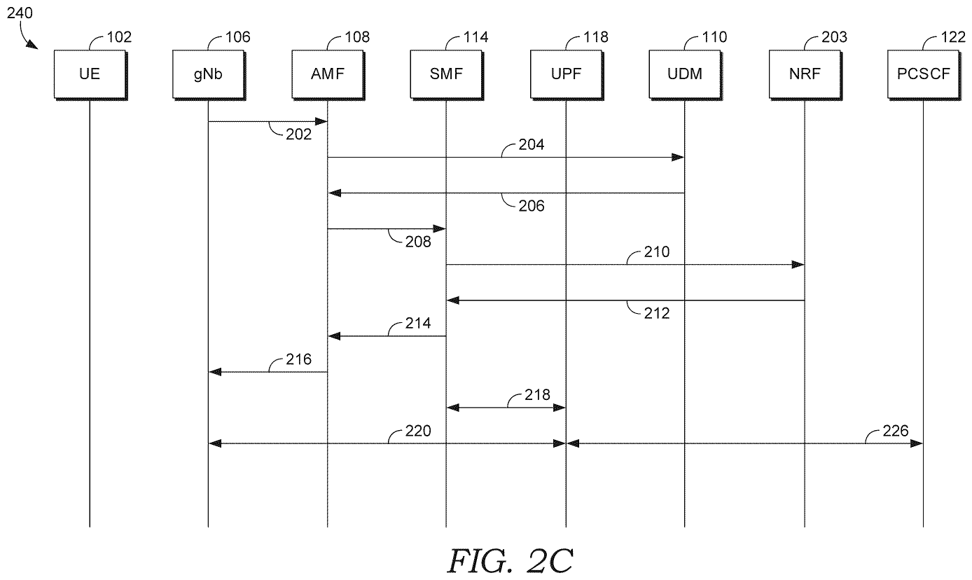

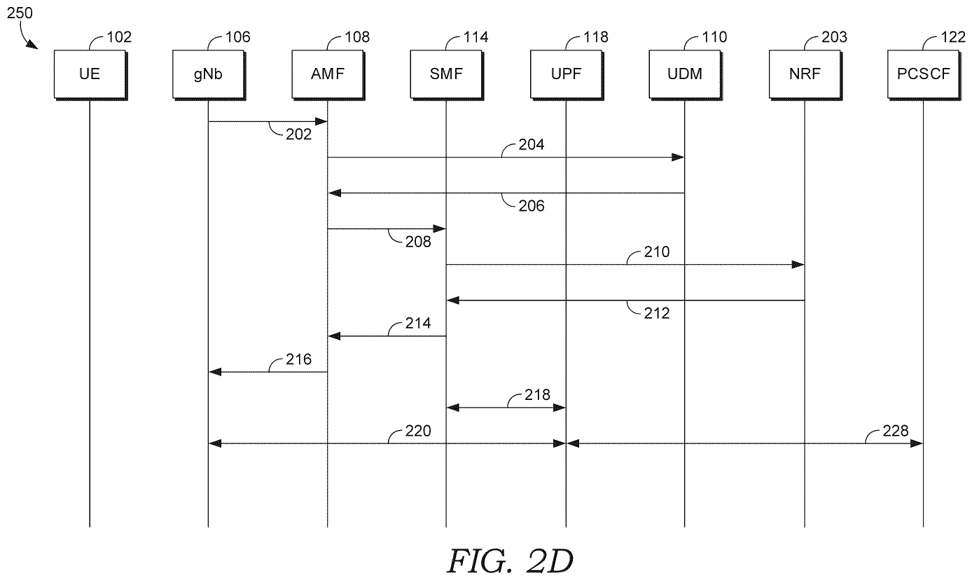

Although not depicted in FIG. 1 to maintain visual clarity, the 5G core network 103 may further include a Network Repository Function (NRF). The NRF provides service discovery functionality, allowing network functions such as the SMF 114 to dynamically locate other services, like the P-CSCF 122 of the IMS network 120, based on policies or slice-specific requirements. The NRF is logically connected to the other 5G core 103 components via the Nnrf interface, which facilitates these interactions. The Nnrf interface is a standardized interface that supports registration and discovery operations between network functions and the NRF. The NRF is depicted in later figures (e.g., FIG. 2A) as component 203 to illustrate this discovery process in more detail, and additional discussion of both the NRF and Nnrf interface is provided below with reference to FIGS. 2A-2D.

Moving along, the N3 interface connects the gNodeB 106 to the UPF 118 and operates on the user plane of the 5G core network 103, where it is responsible for transporting user data traffic into the core network 103. When the data network name (DNN) or access point name (APN) corresponds to IMS services, the N3 interface carries IMS-related traffic—such as Session Initiation Protocol (SIP) signaling and Real-Time Transport Protocol (RTP) media—from the UE 102 through the gNodeB 106 to the UPF 118. The UPF 118 then routes this traffic over the N6 interface toward the IMS network 120.

The IMS network 120 is also shown as interacting with the 5G core 103 through components such as the proxy-call session control function (P-CSCF) 122, which serves as the entry point for signaling messages within the IMS network 120 from the 5G core network 103. The P-CSCF 122 is responsible for enforcing policies, ensuring session security, and processing session initiation protocol (SIP) signaling related to UE communication.

The UDM 110 is responsible for obtaining subscriber data that the SMF 114 accesses for managing user sessions on the network. Communications between the UDM 110 and the SMF 114, including requests from the SMF 114 to the UDM 110 and responses from the UDM 110 to the SMF 114, use the N10 interface. The UDM 110 can obtain subscriber data requested by the SMF 114 from the UDR 112 that stores the user information. While only one UDR is shown for simplicity in FIG. 1, it should be understood that the UDM 110 can be associated with more than one UDR. The PCF 116 communicates with the SMF 114 over the N7 interface to provide session-specific policies, including QoS configurations, access control, and charging rules, ensuring compliance with network operator policies. Additionally, the IMS network 120 is depicted as either an integral part of the network environment 100 or as a separate, yet functionally connected, subsystem that depends on information exchanged with the 5G core 103.

The N4 interface facilitates communication between the SMF 114 and the UPF 118. As part of the control plane, the SMF 114 uses the N4 interface to transmit control instructions and policy configurations to the UPF 118, which resides in the user plane. The SMF 114 operates as a centralized traffic manager within the 5G Core, responsible for maintaining session information, enforcing QoS policies, and managing slice ID information critical for enabling network slicing. Conversely, the UPF 118 functions as the user-plane entity that executes the SMF's 114 instructions (e.g., forwarding packets and applying the session-specific configurations). The N4 interface is critical for enabling dynamic management of user traffic by the UPF 118, including tasks such as packet forwarding, QoS enforcement, and application of session-specific rules. Additionally, network slicing—a key feature of 5G—relies on the N4 interface to propagate slice-specific information needed for delivering tailored services, such as ultra-reliable low latency for gaming or high throughput for video streaming. Without the N4 interface, the UPF 118 would lack the necessary slice-level context to appropriately handle traffic, as the UPF 118 does not inherently store or interpret slice information.

Network slicing allows the creation of virtualized network segments, each optimized for specific services, such as enhanced reliability for IoT devices. The N4 interface facilitates the transmission of slice-specific information to support these requirements. The 5G core network 103 acts as the brain of the network environment 100, holding slice ID information necessary for proper service segmentation, while the IMS network 120 typically lacks access to this information. Within the 5G core network 103, the SMF 114 ensures that the slice ID and its associated policies are transmitted to the UPF 118 in real time via the N4 interface. The UPF 118 embeds this slice information into signaling messages or data packets, bridging the gap between the 5G core network 103 and external networks, such as the IMS network 120. This communication is essential because the UPF 118 itself does not interpret slice-specific policies but instead relies on directives from the SMF 114. In aspects, the N4 interface enables the SMF 114 to transmit network slice information, including slice-specific identifiers and associated parameters, to the UPF 118. This information allows the UPF 118 to implement slice-aware functionality by embedding network slice data into signaling messages or data packets destined for the IMS network 120. In aspects, the network slice information includes one or more of a network slice identifier uniquely identifying a network slice associated with the UE; a QoS profile associated with the network slice; security parameters specific to the network slice; performance metrics associated with the network slice, including latency or throughput thresholds; mobility restrictions or preferences for the network slice; and/or application-specific policies tied to the network slice.

Once the UPF 118 embeds this information into signaling messages or data packets, the P-CSCF 122 of the IMS network 120 can dynamically apply policies tailored to the specific slice. In aspects, the P-CSCF can apply the policies in real-time or near real-time when the user registers the UE 102 with the 5G core network 103 based on real-time slice performance metrics or user behavior. In some examples, the P-CSCF 122 may send feedback to the SMF 114 or the UPF 118 about the performance of slice-based policies, allowing dynamic updates to the slice configuration. For example, these policies may include subscriber-specific configurations, such as encryption for secure transactions, QoS adjustments to ensure low latency for streaming, or bandwidth prioritization for high-demand applications. In various embodiments, this transmission ensures that slice-specific configurations, such as QoS and policy enforcement, are consistently extended beyond the 5G core network 103 to downstream components, including the IMS network 120 in real-time or near real-time. By passing slice ID information early—particularly during the UE registration process—the IMS network 120 can apply slice-aware policies immediately, reducing latency and improving service quality for end users.

Turning to FIGS. 2A-2D, flow diagrams 200, 230, 240, and 250 are provided illustrating four different flows to communicate 5G network slice information to the IMS network. Initially, at step 202, the flow 200 begins when a UE 102 initiates a protocol data unit (PDU) session establishment request via the gNodeB 106. A PDU session is a logical connection established between a UE (e.g., UE 102) and a data network (e.g., gNodeB 106), enabling the exchange of data packets. This session establishment request is received by the AMF 108 over the N2 interface. The initiation of the PDU session at step 202 provides the foundation for transmitting slice information downstream to enable slice-aware routing and policy enforcement.

At step 204, the AMF 108 transmits a network UDM (e.g., Nudm) UE context management (UECM) registration request. A Nudm UECM registration request refers to a signaling procedure in the 5G core network where the AMF 108 communicates with the UDM 110 over the N8 interface, and is initiated during the user registration process. It allows the AMF 108 to register or update the UE's 102 context information, such as its subscription data, network slice selection assistance information (NSSAI), and other parameters essential for mobility and session management in the 5G core. Step 204 ensures that the UE 102 is associated with the appropriate network slices and services during its active sessions. At step 206, the UDM 110 provides a Nudm response back to the AMF 108. This response includes NSSAI values that correspond to slice-specific identifiers (S-NSSAI). In aspects, the AMF 108 incorporates this NSSAI into subsequent signaling messages to ensure that the UE 102 is assigned to the appropriate network slice.

At step 208, the AMF 108 creates a PDU Session with the SMF 114. As described in relation to step 202, this session provides a pathway for data transmission (e.g., internet or application data). The PDU Session at step 208 creates a session management (SM) context request. In aspects, the SM context includes details about the UE's 102 data session (e.g., QoS requirements, slice information, network policies, etc.). It is contemplated that the AMF 108 received the NSSAI during the registration of step 204, so the AMF 108 can include the S-NSSAI in the request to the SMF 114 at step 208. In aspects, the mobile network operator (MNO) may obtain a SMF of the 5G core network, the network slice information associated the UE 102 based on the NSSAI.

Upon receiving the NSSAI, at step 210, the SMF 114 interacts with the Network Repository Function (NRF) 203 over the Nnrf interface. The NRF 203 is a central component of the 5G core network that acts as a directory for network functions (NFs). Its primary role is to allow other NFs to discover services provided by other NFs dynamically. At step 210, the SMF 114 is interacting with the NRF 203 to discover NFs such as the appropriate P-CSCF (e.g., P-CSCF 205) in the IMS network. In aspects, the SMF 114 may use the slice ID to determine which P-CSCF should be selected for Proxy Configuration Option (PCO) operations. The NRF 203 then responds at step 212 with discovery information, which the SMF 114 uses to configure the PDU session accordingly.

At step 214, the SMF 114 responds to the AMF 108 with a PDU SM context response, completing the configuration of slice-specific parameters. The AMF 108 then transmits a PDU session establishment response to the gNodeB 106 at step 216, allowing the UE 102 to begin utilizing the assigned slice.

At step 218, the MNO system transmits the network slice information from the SMF 114 to the UPF 118 via the N4 interface. As described above in FIG. 1, the N4 interface serves as a critical conduit for transmitting control plane information, including slice-specific identifiers and policies, from the SMF 114 to the UPF 118. The UPF 118 then uses this information to classify outgoing traffic and apply slice-specific markings based on predefined mapping techniques, ensuing correct policy enforcement at the IMS level.

Starting at step 220, it is contemplated that there are at least four different paths to communicate slice-ID information from the 5G core network to the IMS network, illustrated in FIGS. 2A-2D. Specifically, step 220 represents the start of user plane traffic flow over the N3 interface from the gNodeB 106 to the UPF 118, enabling transmission of IMS-related signaling and media data. Very generally, the MNO system may embed the network slice information into one or more of signaling messages or data packets at the UPF, wherein the signaling messages or data packets are destined for the IMS network. Next, the MNO system may transmit the network slice information to the P-CSCF 122 of the IMS network where the MNO system may enable enforcement of one or more network policies or configurations at the IMS network based on the specific network slice information.

Generally, the UPF 118 may select a mapping technique for embedding the network slice information based on network configuration or policy, and transmits the network slice information to the IMS network, wherein the network slice information is retrievable using a corresponding technique for performing slice-specific functional enhancements. In various aspects, the UPF 118 may map the network slice information to one or more of a differentiated service parameter or a transport layer header, and transmits the network slice information to the IMS network, wherein the network slice information is retrievable by the IMS network by unmapping the respective parameter or header. In alternative aspects, the UPF 118 may embed the network slice information into one or more of a custom header or a custom message body of a Session Initiation Protocol (SIP) message, and transmits the SIP message to the IMS network, wherein the network slice information is retrievably extracting the respective custom header or custom message body. The four different paths to illustrate this are set out below and in FIGS. 2A-2D.

For example, FIG. 2A illustrates a method for communicating 5G network slice information using Differentiated Services Code Point (DSCP) markings. By using DSCP markings, this method enables slice-aware policy enforcement at the IMS level without requiring modifications to existing DSCP-based traffic classification logic.

The UPF 118 embeds the slice ID into outgoing IP packets by modifying the DSCP field in the IP header. This marking allows downstream IMS components to differentiate traffic based on slice requirements. For example, traffic associated with ultra-reliable low-latency applications may be marked with a DSCP value corresponding to a high-priority slice, while traffic for best-effort services is marked with a lower-priority DSCP value.

At step 220, user plane traffic flows from the gNodeB 106 to the UPF 118 via the N3 interface, and from the UPF to the IMS network via the N6 interface at step 222. In aspects, the UPF 118 transmits traffic to the P-CSCF 205 in the IMS network, embedding the DSCP markings in the IP header. The P-CSCF then uses these markings to enforce slice-specific policies, leveraging pre-configured mappings between DSCP values and policy parameters. In aspects, the UPF 118 maps the network slice information to a differentiated service parameter, and transmits the network slice information to the IMS network, wherein the network slice information is retrievable by the IMS network by unmapping the differentiated service parameter. For example, the P-CSCF may enforce policies such as IPSec encryption for secure transactions, SRTP support for real-time streaming, or QoS adjustments to ensure low-latency performance for gaming applications.

FIG. 2B depicts a method 230 for incorporating slice-specific information into Session Initiation Protocol (SIP) signaling messages through the use of a custom header shim. A custom header shim is a lightweight, intermediate layer of data added to the header of a packet or signaling message to include supplementary metadata. This shim contains key details, such as the slice ID (e.g., S-NSSAI), QoS parameters, or other slice-specific attributes, and is designed to enrich the packet with additional information that downstream network components, such as the PCF 116 in the IMS network, can parse and interpret. Importantly, the custom header shim enhances the flexibility and granularity of slice-specific information transmission while preserving compatibility with existing packet inspection and processing methods.

Generally, the UPF 118 may map the network slice information to a custom transport layer or IP level header (e.g., shim), which then transmits the network slice information to the IMS network, in the network slice information is retrievable by the IMS network by unmapping the transport layer. Steps 202-216 are the same as described with respect to FIG. 2A. The process of adding a custom header shim begins at step 218 with the SMF 114 providing the UPF 118 with slice-specific data, including the S-NSSAI and associated parameters, over the N4 interface. It is contemplated that this information is formatted into the shim as an additional field in the packet header. The shim adheres to a predefined structure to ensure compatibility with packet inspection tools and downstream network components. For example, it may include structured key-value pairs, such as Slice-ID: <value>or QoS: <parameters>, to convey relevant information in a standardized format. The UPF 118 then embeds the shim into the SIP message header, either as an extension of the existing SIP headers or as a separate, clearly marked field dedicated to custom data. Similar to FIG. 2A, at step 220, user plane traffic flows from the gNodeB 106 to the UPF 118 via the N3 interface.

Once the SIP message containing the custom header shim is transmitted over the N6 interface at step 224, it is received by the IMS network. At this stage, the PCF 116 parses the shim and applies dynamic, slice-specific policies based on the embedded information. These policies may include enhanced encryption for secure communications, prioritized bandwidth allocation for specific services, or QoS adjustments tailored to the requirements of the slice. The use of a custom header shim allows for the seamless and granular transmission of slice-specific metadata without altering the fundamental structure of the SIP message. Furthermore, it ensures backward compatibility, as NFs that do not recognize the custom shim can safely ignore it without disrupting the core functionality of the message. The process of FIG. 2B provides enhanced flexibility and granularity compared to DSCP markings (FIG. 2A) while remaining compatible with existing packet inspection methods.

FIG. 2C demonstrates a process 240 involving deep packet inspection (DPI) to insert slice-specific information into a custom SIP header containing NASSAI slice ID. Generally, the custom SIP header is then unmapped at the P-CSCF 122 for specific per slice-ID functional enhancements. Steps 202-216 are the same as described with respect to FIG. 2A. In aspects, the SMF 114 transmits the slice ID to the UPF 118 over the N4 interface at step 218. At step 226, the UPF 118 performs DPI on SIP signaling traffic and inserts or embeds a custom SIP header with network slice information, such as “P-Slice-Id,” into the SIP messages on the N6 interface, which is then transmitted to the IMS network. The P-CSCF 130 in the IMS network parses or extracts this custom SIP header to identify the slice information and applies policies tailored to the specific slice.

FIG. 2D describes a process 250 similar to the approach in FIG. 2C but uses a custom extension markup language (xml) body to the SIP message that includes NASSAI slice ID within signaling messages to convey slice information at step 228. The custom xml body is then unmapped at the P-CSCF 122 for specific per slice-ID functional enhancements. In the context of FIG. 2D, xml is used to encapsulate slice-specific information, such as the NSSAI slice ID, within the body of a SIP signaling message. The xml body follows a structured format, allowing the P-CSCF 122 to efficiently extract and interpret the slice ID for per slice-ID functional enhancements.

It is contemplated that the SMF 114 transmits the slice ID to the UPF 118 via the N4 interface at step 218. The UPF 118 then appends the slice-specific information in an xml format, such as <slice-id>NSSAI</slice-id>, within the body of the signaling message on the N6 interface at step 228. The P-CSCF 130 forwards this xml-embedded message to the PCF 116, which interprets the slice information and enforces slice-specific policies.

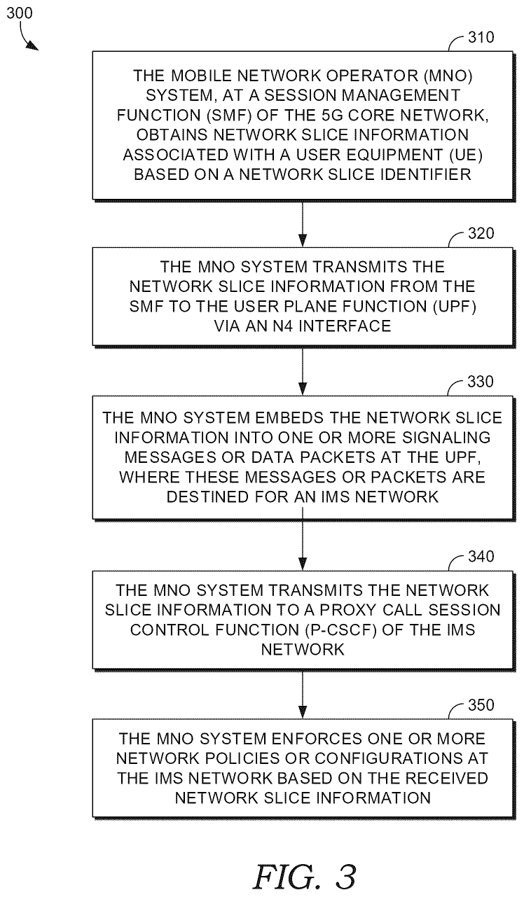

FIG. 3 illustrates a flow diagram 300 for enabling communication between a 5G core network and an IMS network. At block 310, the MNO system obtains, at a Session Management Function (SMF) of the 5G core network, network slice information associated with a User Equipment (UE) based on a network slice identifier (S-NSSAI). The process then proceeds to block 320, where the MNO system transmits the network slice information from the SMF to the User Plane Function (UPF) via the N4 interface. At block 330, the UPF embeds the network slice information into one or more signaling messages or data packets, wherein the messages or packets are destined for the IMS network. The process continues at block 340, where the MNO system transmits the network slice information to a Proxy Call Session Control Function (P-CSCF) of the IMS network over the N6 interface. At block 350, the MNO system enables enforcement of one or more network policies or configurations at the IMS network based on the specific network slice information received.

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 5 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 416 may include a display, a speaker, and/or other components that may present information (e.g., a display, a screen, a lamp (LED), a graphical user interface (GUI), and/or even lighted keyboards) through visual, auditory, and/or other tactile cues.

Radio 424 represents a radio that facilitates communication with a wireless telecommunications network. Illustrative wireless telecommunications technologies include CDMA, GPRS, TDMA, GSM, and the like. Radio 424 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 418 may take a variety of forms. Exemplary I/O ports may include a USB jack, a stereo jack, an infrared port, a firewire port, other proprietary communications ports, and the like. Input/output (I/O) components 420 may comprise keyboards, microphones, speakers, touchscreens, and/or any other item usable to directly or indirectly input data into the computing device 400.

Power supply 422 may include batteries, fuel cells, and/or any other component that may act as a power source to supply power to the computing device 400 or to other network components, including through one or more electrical connections or couplings. Power supply 422 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A method for enabling communication between a 5G core network and an internet protocol multimedia subsystem (IMS) network, the method comprising:
obtaining, by a mobile network operator (MNO) system, at a session management function (SMF) of the 5G core network, network slice information associated with a user equipment (UE) based on a network slice identifier;
transmitting, by the MNO system, the network slice information from the SMF to a user plane function (UPF) via an N4 interface;
embedding, by the MNO system, the network slice information into one or more of signaling messages or data packets at the UPF, wherein the signaling messages or data packets are destined for an IMS network;
transmitting, by the MNO system, the network slice information to a proxy call session control function (P-CSCF) of the IMS network; and
enabling, by the MNO system, enforcement of one or more network policies or configurations at the IMS network based on the network slice information.

2. The method of claim 1, wherein the UPF maps the network slice information to a differentiated service parameter, and transmits the network slice information to the IMS network, wherein the network slice information is retrievable by the IMS network by unmapping the differentiated service parameter.

3. The method of claim 1, wherein the UPF maps the network slice information to a transport layer, and transmits the network slice information to the IMS network, wherein the network slice information is retrievable by the IMS network by unmapping the transport layer.

4. The method of claim 1, wherein the UPF inspects packet data and embeds the network slice information into a custom header of a Session Initiation Protocol (SIP) message, and transmits the SIP message to the IMS network, wherein the network slice information is retrievable by extracting the custom SIP header.

5. The method of claim 1, wherein the UPF inspects packet data and embeds the network slice information into a custom message body of a Session Initiation Protocol (SIP) message, and transmits the SIP message to the IMS network, wherein the network slice information is retrievable by the IMS network by extracting the custom message body.

6. The method of claim 1, wherein the UPF maps the network slice information to one or more of a differentiated service parameter or a transport layer header, and transmits the network slice information to the IMS network, wherein the network slice information is retrievable by the IMS network by unmapping the respective parameter or header.

7. The method of claim 1, wherein the UPF embeds the network slice information into one or more of a custom header or a custom message body of a Session Initiation Protocol (SIP) message, and transmits the SIP message to the IMS network, wherein the network slice information is retrievably extracting the respective custom header or custom message body.

8. The method of claim 1, wherein the UPF selects a mapping technique for embedding the network slice information based on network configuration or policy, and transmits the network slice information to the IMS network, wherein the network slice information is retrievable using a corresponding technique for performing slice-specific functional enhancements.

9. A system for enabling communication between a 5G core network and an IMS network, the system comprising:
one or more processors; and
one or more computer-readable media storing computer-usable instructions that, when executed by the one or more processors, cause the one or more processors to:
obtain network slice information associated with a user equipment (UE) based on a network slice identifier at a session management function (SMF) of the 5G core network;
transmit the network slice information from the SMF to a user plane function (UPF) via an N4 interface;
embed the network slice information into one or more of signaling messages or data packets at the UPF, wherein the signaling messages or data packets are destined for an IMS network;
transmit the network slice information to a proxy call session control function (P-CSCF) of the IMS network; and
enable enforcement of one or more network policies or configurations at the IMS network based on the network slice information.

10. The system of claim 9, wherein the UPF maps the network slice information to a differentiated service parameter, and transmits the network slice information to the IMS network, wherein the network slice information is retrievable by the IMS network by unmapping the differentiated service parameter.

11. The system of claim 9, wherein the UPF maps the network slice information to a transport layer header and transmits the network slice information to the IMS network, wherein the network slice information is retrievable by the IMS network by unmapping the transport layer.

12. The system of claim 9, wherein the UPF inspects packet data and embeds the network slice information into a custom header of a Session Initiation Protocol (SIP) message, and transmits the SIP message to the IMS network, wherein the network slice information is retrievable by extracting the custom SIP header.

13. The system of claim 9, wherein the UPF inspects packet data and embeds the network slice information into a custom message body of a SIP message, and transmits the SIP message to the IMS network, wherein the network slice information is retrievable by the IMS network by extracting the custom message body.

14. The system of claim 9, wherein the UPF maps the network slice information to one or more of a differentiated service parameter or a transport layer header, and transmits the network slice information to the IMS network, wherein the network slice information is retrievable by the IMS network by unmapping the respective parameter or header.

15. The system of claim 9, wherein the UPF embeds the network slice information into one or more of a custom header or a custom message body of a SIP message, and transmits the SIP message to the IMS network, wherein the network slice information is retrievable by extracting the respective custom header or custom message body.

16. The system of claim 9, wherein the UPF selects a mapping technique for embedding the network slice information based on network configuration or policy, and transmits the network slice information to the IMS network, wherein the network slice information is retrievable using a corresponding technique for performing slice-specific functional enhancements.

17. A computer-readable medium storing instructions that, when executed by a processor, cause the processor to perform a method for enabling communication between a 5G core network and an internet protocol multimedia subsystem (IMS) network, the method comprising:
obtaining, by a mobile network operator (MNO) system, at a session management function (SMF) of the 5G core network, network slice information associated with a user equipment (UE) based on a network slice identifier;
transmitting, by the MNO system, the network slice information from the SMF to a user plane function (UPF) via an N4 interface;
embedding, by the MNO system, the network slice information into one or more of signaling messages or data packets at the UPF, wherein the signaling messages or data packets are destined for the IMS network;
transmitting, by the MNO system, the network slice information to a proxy call session control function (P-CSCF) of the IMS network; and
enabling, by the MNO system, enforcement of one or more network policies or configurations at the IMS network based on the network slice information.

18. The computer-readable medium of claim 17, wherein the UPF maps the network slice information to a differentiated service parameter, and transmits the network slice information to the IMS network, wherein the network slice information is retrievable by the IMS network by unmapping the differentiated service parameter.

19. The computer-readable medium of claim 17, wherein the UPF maps the network slice information to a transport layer header, and transmits the network slice information to the IMS network, wherein the network slice information is retrievable by the IMS network by unmapping the transport layer.

20. The computer-readable medium of claim 17, wherein the UPF embeds the network slice information into a custom header or a custom message body of a SIP message, and transmits the SIP message to the IMS network, wherein the network slice information is retrievable by extracting the respective custom header or custom message body.
